(19) United States
(12) Patent Application Publication
(10) Pub. No.: US 2024/0035435 A1
(43) Pub. Date: Feb. 1, 2024

(54) ENERGY GENERATION AND STORAGE SYSTEM BASED ON TRAVELING PISTON IN A NON-HORIZONTAL TUBE

(71) Applicant: Hansen Energy Solutions LLC, The Woodlands, TX (US)

(72) Inventors: Henning Hansen, Sirevåg (NO); Kaj Stokkeland, Sirevåg (NO)

(21) Appl. No.: 18/482,179

(22) Filed: Oct. 6, 2023

Related U.S. Application Data
(63) Continuation of application No. PCT/US2022/022813, filed on Mar. 31, 2022.
(60) Provisional application No. 63/171,492, filed on Apr. 6, 2021.

(51) Int. Cl. F03B 13/14

(52) U.S. Cl. CPC F03B 13/145; F03B 13/148; F05B 2260/50; F05B 2210/18

(57) ABSTRACT

An energy conversion and storage system, comprises a piston defining an enclosed volume. The piston has an inlet valve proximate a bottom of the piston and an outlet valve proximate a top of the piston. A guide having a vertical displacement is arranged so that the piston travels along the guide. The guide has a compressed gas outlet proximate a bottom of the guide and is arranged to move gas into the piston when the piston contacts the compressed gas outlet. The guide has a release valve operator disposed proximate a top of the guide and is arranged to open the outlet valve when the piston contacts the release valve operator. A source of compressed gas in communication with the compressed gas outlet. The system has means for converting motion of the piston along the guide into either (i) motion of another object or (ii) electric power.

### CROSS REFERENCE TO RELATED APPLICATIONS

Continuation of International Application No. PCT/US2022/022813 filed on Mar. 31, 2022. Priority is claimed from U.S. Provisional Application No. 63/171,492 filed on Apr. 6, 2021. Both the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

The present disclosure is related to generating energy, e.g., electrical energy using a piston moved within a tube by the energy of buoyancy and gravity. The disclosure also relates to storing energy from other sources, where the stored energy can be exported when the other sources are not delivering energy.

There are a number of energy generating technologies available that produce energy only intermittently, as for example wind turbines creating electric energy when there is sufficient wind, solar panels creating electrical energy when there is sufficient daylight and wave action creating electric energy when there are sufficient waves, among other intermittent source. All intermittent sources are inactive if there is no primary energy source to drive or operate the intermittent source, as for example no or insufficient waves, nighttime or still air. During a substantial part of their operating time, intermittent sources produce excess energy that may be wasted, instead of being stored for later use because of insufficient energy storage capacity. Well-known electric storage includes electrochemical storage such as batteries. However, it is clear to the industry that other energy storage methods are also required for use with intermittent sources, and if such storage methods could also themselves generate electric energy, then there are better commercial opportunities for such storage devices.

### SUMMARY

One aspect of the present disclosure is an energy generating and storage system. The system comprises a piston defining an enclosed volume. The piston has an inlet valve proximate a bottom of the piston and an outlet valve proximate a top of the piston. A guide having a vertical displacement is arranged so that the piston travels along the guide. The guide has a compressed gas outlet proximate a bottom of the guide and is arranged to move gas into the piston when the piston contacts the compressed gas outlet. The guide has a release valve operator disposed proximate a top of the guide and is arranged to open the outlet valve when the piston contacts the release valve operator. A source of compressed gas in communication with the compressed gas outlet. The system has means for converting motion of the piston along the guide into either (i) motion of another object or (ii) electric power.

In some embodiments, the guide comprises a piston tube having liquid disposed therein, the piston disposed in the piston tube and sealingly engaged to an interior wall of the piston tube, and a recirculating tube disposed proximate the piston tube and in liquid communication with respective longitudinal ends of the tube.

Some embodiments further comprise a turbine disposed in a liquid flow path defined by the recirculating tube and the piston tube, wherein motion of liquid imparted by motion of the piston is converted to rotary motion of the turbine.

Some embodiments further comprise at least one wire, rope or cable coupled at one end to the top of the piston, the at least one wire, rope or cable passing through a sheave wheel.

In some embodiments, the at least one sheave wheel is rotationally coupled to an electric generator or a gas compressor.

In some embodiments, the at least one wire, rope or cable is coupled at another end to the bottom of the piston, the system further comprising at least one additional sheave wheel arranged to constrain the at least one wire rope or cable to move in a closed loop.

In some embodiments, the piston or the at least one wire, rope or cable comprises a magnet, the system further comprising at least one wire coil disposed proximate the piston or the at least one wire, rope or cable whereby motion of the magnet induces electric current in the at least one wire coil.

In some embodiments, the guide is disposed in a tube forming part of a support structure for a floating or bottom supported marine platform.

A method for energy generation and storage according to another aspect of this disclosure includes displacing water from an enclosed volume defined by an object with compressed gas at a first depth in a body of water, causing the object to rise from the first depth. When the object reaches a second, shallower depth in the body of water, the compressed gas is displaced with water, causing the object to sink from the second depth to the first depth. When the object rises and sinks, motion of the object is converted to at least one of another form of motion and electrical power.

In some embodiments, the converting motion comprises displacing water along a tube in which the object moves, and using the motion displaced water to operate a turbine.

In some embodiments, the turbine rotates a gas compressor or an electric generator.

In some embodiments, the converting motion comprises moving a wire, rope or cable in around a sheave wheel, and rotationally coupling the sheave wheel to a gas compressor or an electric generator.

In some embodiments, the wire, rope or cable is moved in a closed loop.

In some embodiments, the converting motion comprises moving a magnet or a wire coil attached to the object by a corresponding wire coil or magnet to induce electric current in the wire coil or the corresponding wire coil.

In some embodiments, the converting motion comprises moving a wire, rope or cable having a magnet attached thereto past at least one fixed placement wire coil to induce electric current in the fixed placement wire coil.

In some embodiments, the object comprises a piston. The piston moves in a tube within which the piston is sealingly disposed.

Other aspects and possible advantages will be apparent from the description and claims that follow.

### BRIEF DESCRIPTION OF THE DRAWINGS

FIG. 1 illustrates an example embodiment of a power generating system placed in a body of water such as the ocean.

FIG. 2 illustrates an example embodiment of the traveling piston in more detail.

FIGS. 3A and 3B illustrate in a simplified way how liquids are drawn in behind or pushed forward when the piston is traveling within the piston tube.

FIG. 4 illustrates how wave energy may be used to power an air compressor.

FIGS. 5A through 5E illustrate the system of FIG. 1 wherein a compressed air tube (tank) extends to a selected depth below the bottom of the piston tube. The figures show movement of the piston corresponding to filling the piston with air and replacement of the air with water.

FIGS. 6A through 6E illustrates how a piston for pressure generation may be incorporated in the compressed air tube, as well as how the piston in the piston tube may be expandable to provide increased buoyancy.

FIG. 7 is an example of calculations that demonstrates the buoyancy and gravity of the piston.

FIG. 8 illustrates an example embodiment of cables, ropes or wires that may be coupled to the piston, where motion of the cables, ropes or wires imparted by the piston can be used to generate electric power. The illustrated embodiment may comprise magnets and coils for direct generation of electric power.

FIG. 8A shows a part of the piston tube wall in more detail wherein is shown possible placement of magnets and/or coils.

FIG. 8B shows part of a piston wall from FIG. 8 in more detail to show possible placement of magnets and/or coils.

FIG. 9 illustrates an example embodiment of a power generating system according to the present disclosure fully submerged in a body of water and moored to the water bottom.

FIG. 10 shows example embodiments of support jackets used in marine hydrocarbon production to illustrate a possible implementation of a system according to the present disclosure.

### DETAILED DESCRIPTION

Apparatus and methods according to the present disclosure will be described first with an explanation of the general structure of an apparatus and its principle of operation. Such explanation will be followed by a more detailed description of example embodiments.

A well-known method of transporting an object which defines an enclosed volume, for example a tank, or an inverted basin or dome, from one depth in a body of water to a shallower depth the water is to fill the enclosed volume defined by the object with air, displacing water from within the object. Displacing the water with air creates buoyancy that can lift the object in the water. To sink an air filled object in a body of water, air is typically replaced by water, until the object sinks due to gravity. An energy generating and storage device according to the present disclosure is based on alternately filling a piston with water and displacing the water to enable a piston to travel up and down within a tube. Such movement moves water within the tube so that the moving water can drive an energy converting device such as a turbine.

The present disclosure describes a system which in some embodiments may convert motion of an object by reason of making the object alternatingly buoyant and then non-buoyant into a different form of motion, or converting the motion into electric power directly. In some embodiments, motion of the object may be converted into motion of a liquid. Such embodiment comprises a long, liquid filled tube, which may be oriented vertically, wherein is disposed a piston, tank or chamber (“piston” hereinafter for convenience) that can travel up and down within the tube. The cross-section of the piston may be substantially the same as the cross-section of the tube such that moving the piston in the tube pushes liquid in the tube in the direction of motion of the piston. Volume behind the moving piston has reduced pressure into which liquid can flow. The piston tube and associated components may be submerged in a body of water such as a river, lake or the ocean. Also, this embodiment of the system may be disposed within one or more tubes built into a support structure of high buildings, or as structures placed externally on such buildings. Other possible embodiments may comprise one or more tubes disposed along steep mountain walls, or one or more tubes which form part of the support structure of floating or fixed offshore platforms for oil and gas extraction, wind turbines, or other fixed offshore structures used for power conversion, and the like.

The liquid in the piston tube may be seawater, fresh water, or other suitable liquid. If using greater density liquid than water, the energy generation will improve because the buoyancy of the piston when it is liquid filled will be greater. A second tube, called the circulation tube, is placed alongside the piston tube and is hydraulically connected to the piston tube proximate the lower and upper end of the piston tube.

The term “turbine” is used in this disclosure to describe a device creating rotary motion from liquid that is being moved by the piston, but those skilled in the art will understand that the motion of the liquid may be converted to another form of motion using devices other than turbines.

The liquid can be discharged and/or drawn into the piston tube using one or more turbines, e.g. similar to turbines used for hydroelectric power generation. Such turbines may be mounted on or within the circulation tube, at the interface between the circulation tube and the piston tube or within the piston tube.

Seals may be implemented on the exterior surface of the piston to reduce fluid bypass between the upper and lower side of the piston, thereby improving the efficiency of moving the liquid in the piston tube.

The system may automatically fill the piston with compressed gas or air when the piston lands in the lower end of the piston tube. Compressed gas or air may be supplied from the surface via a tube placed externally of the piston tube, or by compressed air placed at the lower end of the tube. When air displaces the liquid within the piston, water from inside the piston is expelled from the piston. As soon as there is sufficient air in the piston, the buoyancy of the piston will result in the piston traveling upward within the piston tube, drawing in liquid below and pushing liquid ahead of the travel direction. The displaced liquid will provide energy to rotate the turbine(s).

When the piston reaches the top of the piston tube, the air within is released from the top of the piston and is displaced with liquid. The displacing liquid makes the piston lose buoyancy, where it will sink by gravity to the bottom of the piston tube again. During piston sinking, the liquid moved in front of and behind the piston within the piston tube will provide energy to rotate the turbine(s).

Some embodiments may make more efficient use of the compressed air or gas that is used to displace liquid from the piston. Such embodiments may reuse the pressurized air or gas from within the piston instead of venting the air or gas to the outside environment when the piston reaches the top of its travel in the piston tube. When the air is released from the piston, which air is at a pressure at least as great as the hydrostatic pressure in the body of water where the piston tube is located, can be vented into one or several low-cost pre-booster tanks or other pressure sealed storage container. Such pre-booster tanks may be implemented as one or several tubes placed externally to the piston tube. The pre-booster tubes may be, for example, oil well tubulars such as 2-⅞″ outer diameter (OD) production tubing. Such tubing may be recycled tubes obtained from abandoned or reworked hydrocarbon producing wellbores.

The reciprocating motion of the piston in the piston tube will continuously repeat as long as compressed air or gas is supplied to the bottom of the piston tube, allowing the system to generate close to a continuous energy output. A plurality of such generator units can be placed close to each other, having pistons that are not motion-synchronized with each other. In this way, a plurality of such generator units may provide substantially continuous, uninterrupted power supply.

Energy generated by the rotating turbine(s) may be exported for one or more external uses, but a portion of the energy so generated may be used to operate a compressor for the air, because the air needs to have a sufficient pressure to evacuate the water from within the piston when the piston is at the lower end of the piston tube. In some embodiments, compressed air may be provided by prefilled bottles or tanks coupled to the compressed air supply tube.

The generator unit may also be used for storing energy from other such generator units or from other types of energy generating devices (e.g., wind turbines, solar panels, wave powered generators, etc.), where excess power from such other types of devices can be used to compress air required to operate the herein described power generator. Then, when power delivered from such other generating devices is insufficient for connected loads, the compressed air may be used to power the generator unit described herein.

An alternative to filling a piston with air, and releasing the air when the piston reaches an upper travel limit, is to release air below a sinking piston only. This will push the piston up in the piston tube, generating energy by displacing liquid in the tube. When the piston reaches the upper travel limit, the air is released from underneath the piston, resulting in this sinking into the piston holding tube again.

The speed of travel of the piston will depend on the pressure drop or flow restriction induced by the turbine(s) as well as moving liquid friction in the various connected tubes. Hence, the speed of piston travel can be controlled to some degree by changing these parameters as well as the amount of liquid or air moved within the piston.

The traveling piston, when sinking in the piston tube, can be hydraulically coupled to pre-booster tank(s), which means that the pressure generated in front of the piston is also assisting in pressurizing the air in the pre-booster tank(s).

The system described herein is contemplated being installed in the ocean, where the system may be suspended by floats disposed at or close to the water surface, and where the piston tube is anchored to the water bottom. Locating the generator system in the ocean as described provides the ability to add other power generating devices to the system, for example wave energy converters, compressors and the like. The entire system may be submerged at sufficient depth in the water, so that vessels can pass overhead without risk to the system.

In some embodiments, a system according to the present disclosure may be mounted in boreholes on land, along mountain walls, along high-rise building walls, etc.

A system according to the present disclosure may be used within tubular risers for floating or seafloor moored windmill power generating systems. Buoyancy for such windmills may be obtained by floats placed externally.

In addition, the support structure (also sometimes referred to as “jackets”) for floating or bottom-supported windmills, oil and gas extraction platforms, accommodation platforms, and the like, which have vertical and/or close to vertical tubes that form part of the jacket structure may be used in some embodiments to house the energy generation system described herein. Such jackets are known to be built from a number of tube sections, where one or several of such tube sections may be used to enclose the energy generation system, to contain pressurized air, etc. It will be understood that the jackets used to support one or several wind turbines may benefit from using the energy generator and storage system described herein when used to store energy, whether as compressed gas or otherwise.

Although the system described uses circulating liquid between the piston tube and recirculating tube, some embodiments may discharge the operating liquid to the sea via one or several power generating turbines when sea water is used as the circulating liquid. Such discharge can be performed when piston travels downward in the piston tube, where the liquid is discharged to the sea from the lower end of the piston tube. When the piston travels upward, the liquid may be discharged to the sea from the upper end of the piston tube. Seawater may also be drawn in from the surrounding water in the lower or upper end of the piston tube as the case may be.

It should also be noted that by having the air tube (or a tank) extending to a depth below the lower end of the piston tube, and venting the air tube to the water from the lower end of piston tube, the increased hydrostatic pressure within the air tube by the seawater will be higher than the pressure required to displace the fluid within the piston with air when initiating the lift of the piston. When the system is anchored to the water bottom, changes in tidal or wave height may provide extra pressure into the air tube that can be harvested to provide energy to further compress the air.

An additional source of energy may also be harvested by running the air releasing from the piston or injected into the piston through an air powered turbine.

Some embodiments may use a different mechanism to convert motion of the piston into other forms of motion. In one such embodiment, the piston may be connected to one or several cables, wires or ropes, where the cables, wires or ropes are drawn through a pulley system coupled to a power generating device. Wires, cables or ropes may also be coupled to the lower end of the piston, where they may exit the lower end of the piston tube through a pulley system, also generating power by movement of the cable, wires or ropes. The cables, wires or ropes in the upper end of the piston tube may have weights attached to such end, while the cables, wires or ropes in the lower end may have floats connected to such end. Another embodiment may have cables, wires or ropes connected externally to the piston tube, obviating the need for weights or floats.

The manner of using wires or ropes, as well as the previously described implementations having an untethered piston moving within a tube allows also for the introduction of a rod or tube in the center of the piston tube, where the piston moves externally to such rod or tube. Within the rod or tube, magnets and/or coils may be built in, connected be electrical cable(s) to any point, e.g., the water surface, where electric power may be used. Implementing coils and/or magnets in the piston will result in electricity being generated directly (rather than rotating a turbine) as the piston travels up and down. One or more magnets may be implemented in the piston, as well as magnets mounted into and along the piston tube. As the piston travels past these tube mounted magnets, electricity will be generated. The tube can be assembled in one continuous length, or it may be assembled using shorter sections of tube connected end to end. So-called internally flush type wellbore casing may be a suitable example of a structure used to assemble the piston tube because such tube structure will reduce fluid bypass when the piston travels across tubular connection joints. Such embodiments using magnets and coils to convert motion of the piston to electric power may omit the piston tube and the recirculation tube. In some embodiments, the piston tube may be substituted by a simple guide to constrain motion of the piston.

Tubes may be assembled at the location where the generator system is to be mounted, assembled on land or near shore in the ocean. The system in some embodiments may be towed to location in the same fashion as underwater pipelines are transported.

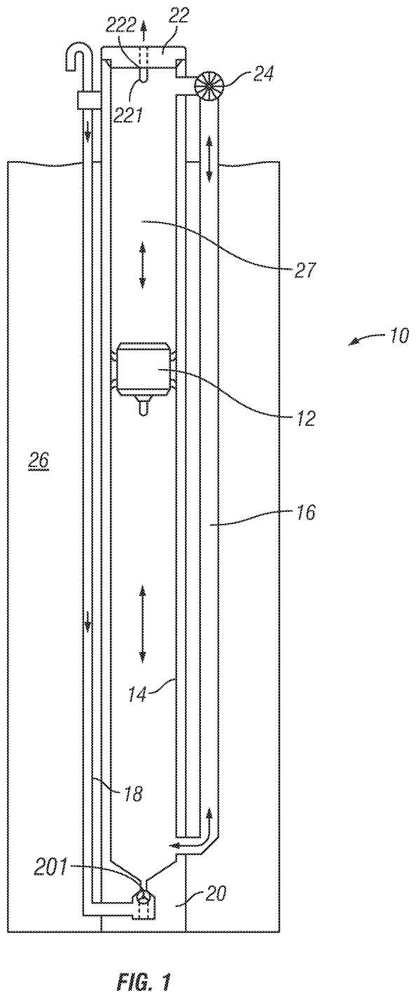

FIG. 1 shows an example embodiment of a power generating and storage system 10 (“system” hereinafter for convenience”) according to the present disclosure to illustrate the principal components. The system 10 may be disposed in a body of water 26 at a convenient chosen depth.

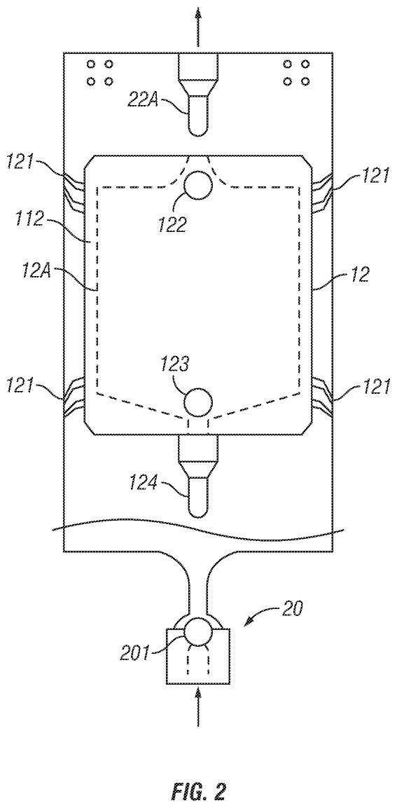

A piston tube 14 may extend a selected length, generally a matter of discretion for the designer. The orientation of the piston tube only requires that there be some vertical separation between the two longitudinal ends of the piston tube 14; it will be appreciated that the system 10 will perform best when the piston tube 14 is oriented vertically. The piston tube 14 may be any shape; as a matter of convenience it may be in the form of a cylinder, wherein the internal wall of the cylinder is smooth along its entire length. A piston 12 may be disposed in the piston tube 14 and be free to move longitudinally within the piston tube 14. The piston 12 may be shaped to facilitate sealing engagement with the interior wall of the piston tube 14 such that movement of the piston 12 within the piston tube 14 most efficiently moves liquid (e.g., sea water) within the piston tube 14 as the piston 12 moves therein. The piston 12 will be explained in more detail with reference to FIG. 2. A lower end of the piston tube 14 may comprise an air charge station 20, pneumatically connected to a compressed air supply tube 18 disposed outside the piston tube 14. Compressed air or other gas may be moved through the air supply tube 18 through a valve 201 in the air charge station 20 and into the piston 12 when the piston 12 fully sinks within the piston tube 14 and engages the air charge station. Sources of compressed air to be moved through the air supply tube 18 will be further explained below. A liquid recirculation tube 16 is hydraulically connected between the upper end and the lower end of the piston tube 14, such that longitudinal movement of the piston 14 within the piston tube 14 displaces liquid (e.g., sea water) 27 in the piston tube 14 such that it moves along the liquid recirculation tube 16. A power takeoff 24, which may be one or more turbines, is connected within the liquid recirculation tube 16 in a manner such that moving liquid resulting from movement of the piston 12 operates the power takeoff to convert energy of the moving liquid into another form of energy, e.g., compression of air or gas, or electric power from a rotationally coupled electric generator or alternator (not shown separately). An air release station 24 is disposed at the upper longitudinal end of the piston tube 14 and may comprise a fitting 221 that cooperates with the upper side of the piston (see FIG. 2) to release air within an enclosed volume defined by the piston 12 and causes the release air to pass through a valve 222 for discharge to the water 26 or transfer to another means of storage, e.g., a tank or reservoir having an internal pressure below the pressure of the air being released from the piston 12. The valve 222 generally prevents water from outside the piston tube 14 from entering the piston tube 14 through the air release station by reason of difference between hydrostatic pressure of the water 26 and hydrodynamic pressure of the liquid 27 moving through the piston tube 14 and the liquid recirculation tube 16.

FIG. 2 an example embodiment of the traveling piston 12 in more detail, as well as upper and lower piston receptacles at the longitudinal ends of the piston tube (14 in FIG. 1). The piston 12 may comprise an impermeable housing 112 made from high strength material such as steel. The housing 112 is shaped to define an enclosed volume 12A for trapping air or gas during operation of the system. An upper valve 122 may be disposed in a suitable seat in the upper part of the housing 112 to retain air within the volume 12A until the upper valve 122 is moved away from its seat by an air release pin 22A disposed in the air release station (22 in FIG. 1) such that air may be displaced from the volume 12A by liquid from below. A corresponding valve 123 at the bottom of the volume 12A enables movement of air or gas under pressure into the volume 12A when the piston 12 is disposed in the air charge station 20. The housing 112 may comprise seals 121 on its exterior surface to reduce liquid blow by when the piston 12 moves along the interior of the piston tube (14 in FIG. 1).

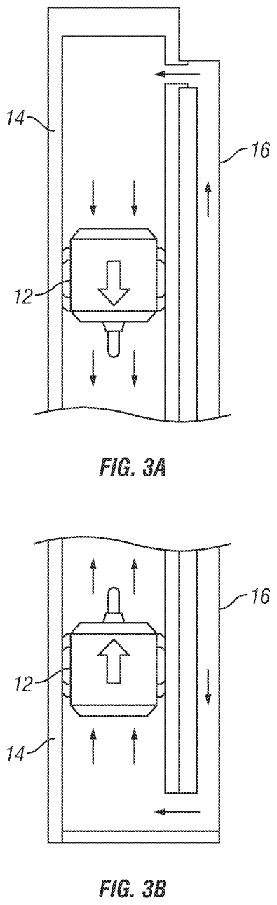

FIGS. 3A and 3B illustrate in a simplified way how liquid is drawn in one side of the piston 12 and is pushed on the opposed side when the piston 12 when the piston 12 is traveling along the piston tube 14; downward in FIG. 3A after all air has been displaced from the volume (12A in FIG. 2) by liquid, and upward in FIG. 3B when the liquid in the volume (12A in FIG. 2) has been displaced by air or gas. In each case, liquid in the liquid recirculation tube 16 moves in the opposite direction to the piston 12 and the liquid in the piston tube 14.

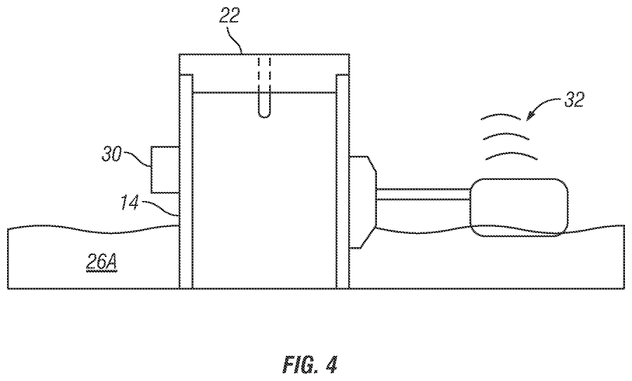

FIG. 4 shows an example embodiment of a system having part of the piston tube 14 disposed above the water surface 26A. A waver operated electric generator 32 may be coupled to or suspended from the piston tube 14 such that wave motion on the water surface 26A generates electric power to operate a compressor 30. Discharge from the compressor 30 may be provided to the air supply tube 18 to operate the system (10 in FIG. 1).

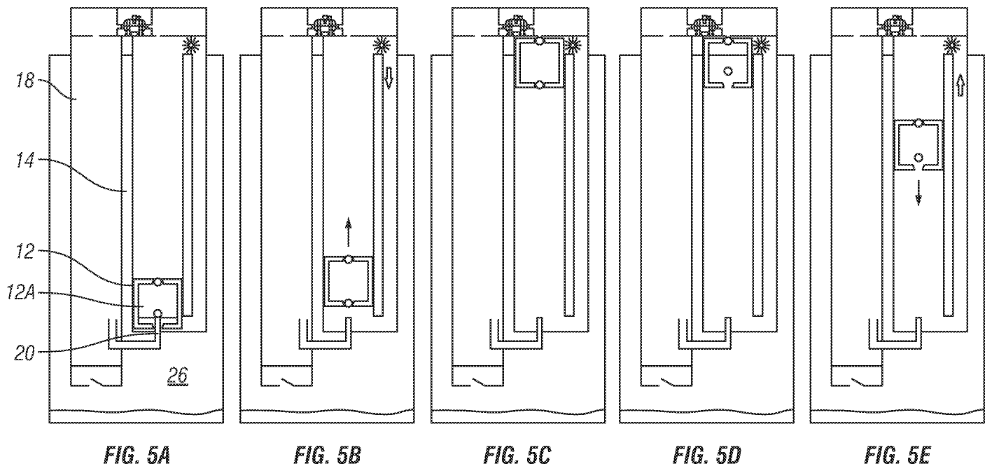

FIG. 5A, B, C, D and E illustrate an entire cycle of operation of the piston 12 in the piston tube 14, from air charge, subsequent piston lift, air discharge and subsequent piston sinking in the piston tube 14. In FIGS. 5A through 5E, the air supply tube 18 extends to a depth below bottom of the piston tube 14, and the bottom of the air supply tube 18 is open to the water 26. In this way, air or gas in the air supply tube 18 is subjected to hydrostatic pressure which is greater than at air charge station 20. That additional pressure can be sufficient for filling the piston 12. It should also be noted that variations in water depth at the check valve 18A due to tidal and wave action can also be used to provide added pressure to the air in the air supply tube 18.

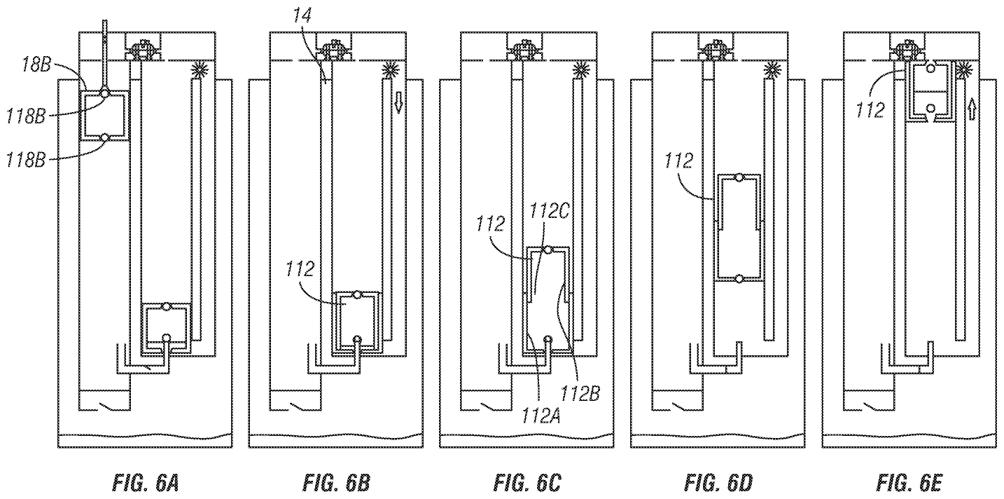

FIGS. 6A through 6E show a complete cycle of piston movement, from air charge to air discharge and sinking within the piston tube 14. FIG. 6A illustrates a gas compression piston 18B disposed in and movable within the air supply tube 18 to provide air compression or supplemental air compression. The gas compression piston 18B may comprise check valves 118B on its upper and lower sides so that the gas compression piston 18B may be lifted within the air supply tube without substantially affecting the air within the air supply tube 18, but will compress the air when the gas compression piston 18B is lowered.

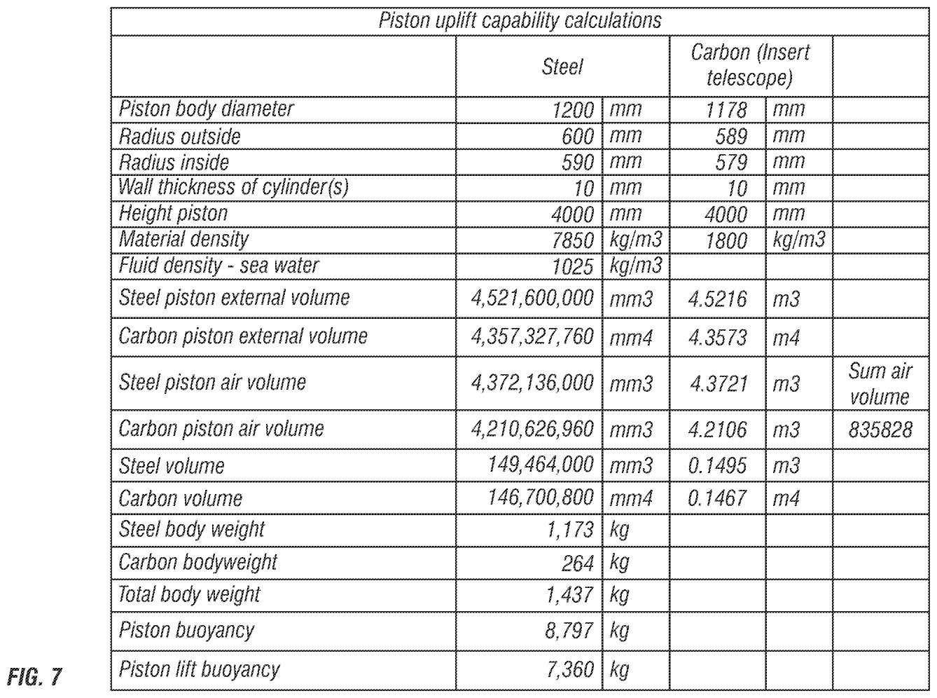

FIG. 7 is an example of calculations that demonstrates the buoyancy and gravity of the piston (12 or 112), where it can be observed that having an expandable piston provides beneficial added buoyancy. An example is if a cylinder (which is the piston) with a diameter of 1200 mm and a height of 4000 mm is used; This alone will have a positive buoyancy of 3300 kg, while adding a carbon cylinder to this creates a buoyancy of 7400 kg. Hence, a significant added hydraulic power can be delivered to the power generator(s), using such a piston expansion method. It should be noted that more air is required to fill the expanded piston than would be the case with a fixed volume piston.

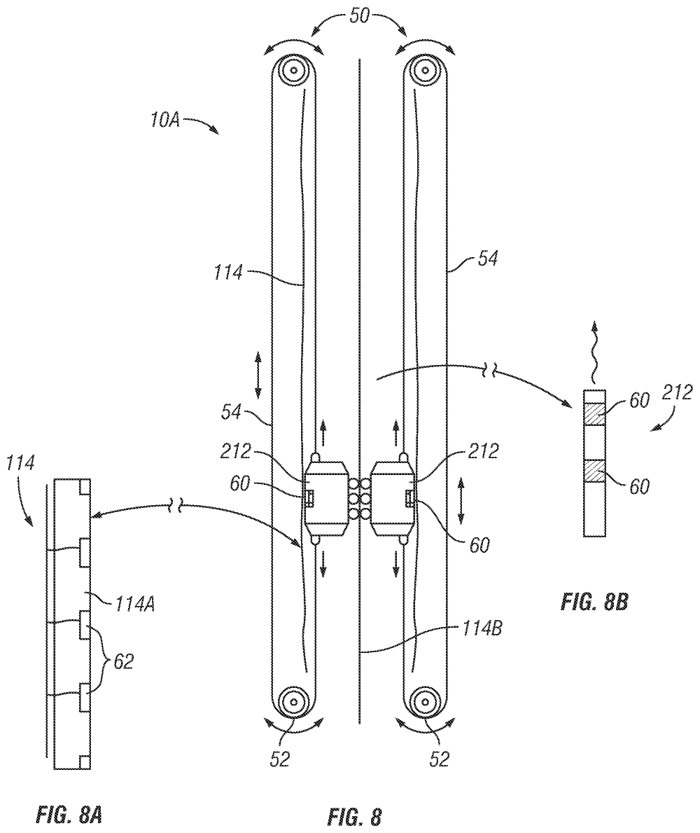

FIG. 8 shows another example embodiment of a power generating system 10A. The embodiment shown in FIG. 8 may comprise one or more pistons 212 each of which defines an enclosed volume and has valve features similar to those in the embodiment explained with reference to FIG. 2. In the present example embodiment, the piston(s) 212 may be made from non-ferromagnetic material, for example plastic or non-magnetic metal such as nickel/chromium alloy.

Referring to FIG. 8B, the exterior wall of the piston(s) 212 may comprise one or more magnets and/or wire coils 60.

Again referring to FIG. 8, in the present example embodiment, the piston(s) 212 may operate substantially as in the previously described embodiments. In the present example embodiment, motion of the piston(s) 212 may be transferred to a wire, rope or cable 54. The wire, rope or cable 54 may be attached at each of its ends to a respective side of one of the piston(s) 212. The wire, rope or cable 54 may pass through respective sheave wheels 50, 52 to form a closed moving loop. Either or both of the sheave wheels 52 may be rotationally coupled to an electric alternator or generator to generate electric power from motion of the piston(s) 212. The piston(s) 212 may move within respective piston tube(s) 114. The respective piston tube(s) 114 may be made from non-magnetic material such as plastic or nickel/chromium alloy. It will be appreciated that in some embodiments only one sheave wheel, e.g., sheave wheel 50 may be used. In such embodiments, the end of the wire, rope or cable 54 opposed to the end coupled to the upper side of the piston(s) 212 may be connected to a weight (not shown) to maintain tension on the wire, rope or cable 54. Mass of the weight (not shown) may preferable be midway between the weight in the liquid (e.g., water) of the piston(s) 212 so that the motion of the piston(s) 212 when positively or negatively buoyant is most effective.

Referring to FIG. 8A, the wall of the piston tube 114 may comprise embedded magnets or wire coils 62 corresponding to the magnets and/or coils (60 in FIG. 8B) in the wall of the piston(s) (212 in FIG. 8). Again referring to FIG. 8, additional electrical power may be generated by motion of the piston(s) 212 with reference to the piston tube 114 by motion of the magnets or coils on the piston with respect to the magnets or coils in the piston tube. It will be appreciated that because the piston is movable, while the piston tube is stationary, it will be more convenient to have magnets in the piston and coils in the wall of the piston tube. However, the opposite arrangement wherein magnets are in the tube and coils are in the piston is equally within the scope of the present disclosure.

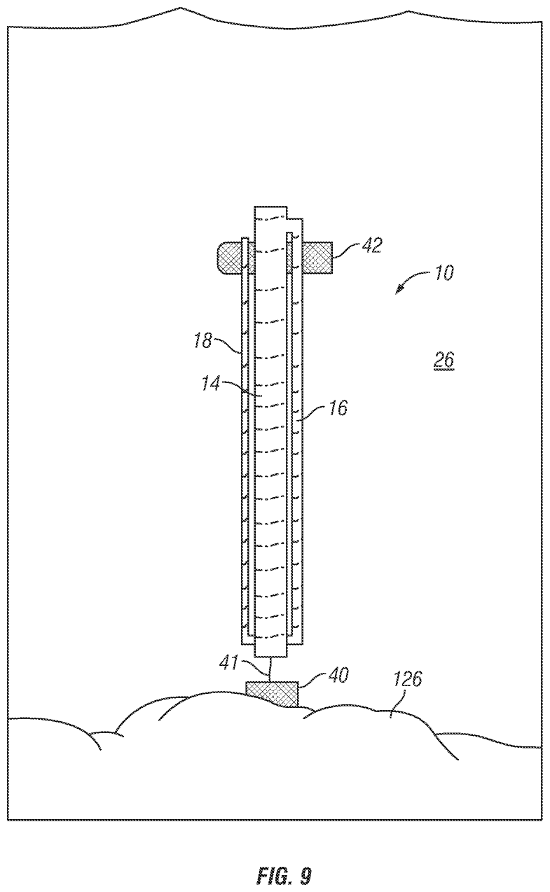

FIG. 9 shows an example embodiment of the system 10 submerged under water 26 wherein the system 10 is moored to the water bottom 126. An anchor base 40, which may be a weight anchor or a suction anchor, is disposed on the water bottom 126. A cable, chain or wire 41 may couple the system 10, e.g., at the bottom of the piston tube 14 to the anchor base 40. One or more floatation devices 42 may be affixed to the system e.g., proximate the top of the piston tube 14 to maintain the system 10 in an approximately vertical orientation. This enables vessels to pass over the system 10, and thereby the system 10 does not disturb marine surface transport in the area of installation.

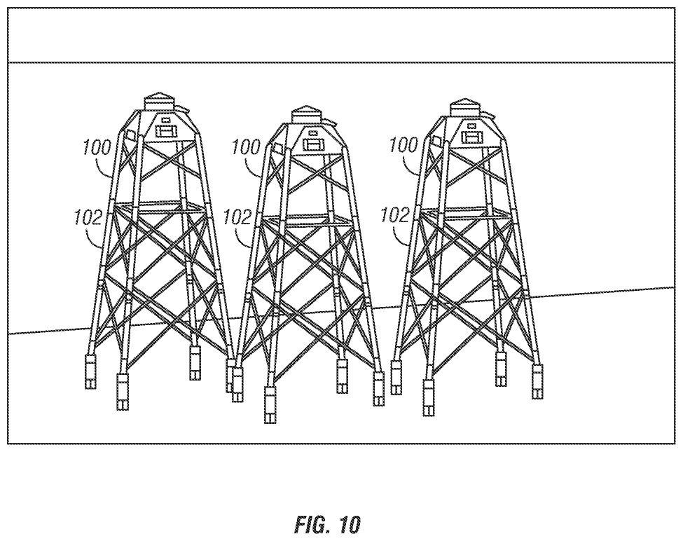

FIG. 10 shows typical offshore jacket structures 100 used as supports for various types of marine platform, as for example used for wind mills, or oil and gas drilling and production platforms. These structures 100 may be landed on the water bottom, called “bottom supported” (e.g., 126 in FIG. 9), extending to above the sea surface, or they may be floating structures moored to the water bottom, wherein the jacket 100 is supported by flotation such as pontoons. The system (e.g., 10 in FIG. 1) may be implemented in one or more of the nearly vertical support tubes 102 of these jackets 100, while other of the support tubes 102 may be used for transporting compressed air. As the tubes 102 are typically not precisely vertical, in such embodiments, the piston(s) (see 12 in FIG. 1) would benefit from having wheels implemented on the exterior surface to reduce friction and improve motion of the piston within the piston tube (14 in FIG. 1).

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. An energy conversion and storage system, comprising:
a piston defining an enclosed volume, the piston having an inlet valve proximate a bottom of the piston and an outlet valve proximate a top of the piston;
a guide having a vertical displacement, the piston arranged to travel along the guide, the guide having a compressed gas outlet proximate a bottom of the guide and arranged to move gas into the piston when the piston contacts the compressed gas outlet;
a release valve operator disposed proximate a top of the guide and arranged to open the outlet valve when the piston contacts the release valve operator;
a source of compressed gas in communication with the compressed gas outlet; and
means for converting motion of the piston along the guide into either (i) motion of another object or (ii) electric power.

2. The system of claim 1 wherein the guide comprises a piston tube having liquid disposed therein, the piston disposed in the piston tube and sealingly engaged to an interior wall of the piston tube, and a recirculating tube disposed proximate the piston tube and in liquid communication with respective longitudinal ends of the tube.

3. The system of claim 2 further comprising a turbine disposed in a liquid flow path defined by the recirculating tube and the piston tube, wherein motion of liquid imparted by motion of the piston is converted to rotary motion of the turbine.

4. The system of claim 1 further comprising at least one wire, rope or cable coupled at one end to the top of the piston, the at least one wire, rope or cable passing through a sheave wheel.

5. The system of claim 4 wherein the at least one sheave wheel is rotationally coupled to an electric generator or a gas compressor.

6. The system of claim 4 wherein the at least one wire, rope or cable is coupled at another end to the bottom of the piston, the system further comprising at least one additional sheave wheel arranged to constrain the at least one wire rope or cable to move in a closed loop.

7. The system of claim 4 wherein the piston or the at least one wire, rope or cable comprises a magnet, the system further comprising at least one wire coil disposed proximate the piston or the at least one wire, rope or cable whereby motion of the magnet induces electric current in the at least one wire coil.

8. The system of claim 1 wherein the guide is disposed in a tube forming part of a support structure for a floating or bottom supported marine platform.

9. A method for energy generation and storage, comprising:
displacing water from an enclosed volume defined by an object with compressed gas at a first depth in a body of water, causing the object to rise from the first depth;
when the object reaches a second, shallower depth in the body of water, displacing the compressed gas with water, causing the object to sink from the second depth to the first depth; and
when the object rises and sinks, converting motion of the object to at least one or another form of motion and electrical power.

10. The method of claim 9 wherein the converting motion comprises displacing water along a tube in which the object moves, and using the motion displaced water to operate a turbine.

11. The method of claim 10 wherein the turbine rotates a gas compressor or an electric generator.

12. The method of claim 8 wherein the converting motion comprises moving a wire, rope or cable in around a sheave wheel, and rotationally coupling the sheave wheel to a gas compressor of an electric generator.

13. The method of claim 11 wherein the wire, rope or cable is moved in a closed loop.

14. The method of claim 9 wherein the converting motion comprises moving a magnet or a wire coil attached to the object by a corresponding wire coil or magnet to induce electric current in the wire coil or the corresponding wire coil.

15. The method of claim 9 wherein the converting motion comprises moving a wire, rope or cable having a magnet attached thereto past at least one fixed placement wire coil to induce electric current in the fixed placement wire coil.

16. The method of claim 9 wherein the object comprises a piston.
